(19) United States
(12) Patent Application Publication
(10) Pub. No.: US 2026/0036557 A1
(43) Pub. Date: Feb. 5, 2026

(54) ACID RAIN COMPOSITION DETECTION CHIP

(71) Applicant: CMA Meteorological Observation Center, Beijing (CN)

(72) Inventors: Junli Jin, Beijing (CN); Dongqing Fang, Beijing (CN)

(21) Appl. No.: 19/274,678

(22) Filed: Jul. 21, 2025

(30) Foreign Application Priority Data
Jul. 31, 2024 (CN) 202411046458.0

(51) Int. Cl. G01N 30/34; G01N 30/86

(52) U.S. Cl. CPC G01N 30/34; G01N 30/8658

(57) ABSTRACT

An acid rain composition detection chip includes one or more processors, and one or more data interfaces, and the processors are configured, through the data interfaces, to read and execute acid rain composition detection instructions stored on a target storage medium, which are configured to: obtain a pH value and an electrical conductivity of a target acid rain sample, and combine with a concentration equilibrium of preset ion species and a thermodynamic model to construct an ion equation system; obtain an approximate solution of the ion equation system; obtain predicted values for the respective ion concentrations; and fuse, based on the pH value and the electrical conductivity, the approximate solution and the predicted values to obtain concentration values of ions in the target acid rain sample. By using the acid rain composition detection chip, it can reduce detection costs, improve detection accuracy and adaptability.

### CROSS-REFERENCE TO RELATED APPLICATION

This application claims priority to Chinese patent application No. CN 202411046458.0, filed to China National Intellectual Property Administration (CNIPA) on Jul. 31, 2024, which is herein incorporated by reference in its entirety.

### TECHNICAL FIELD

The disclosure relates to the field of acid rain detection technology, and particularly to an acid rain composition detection chip.

### BACKGROUND

Acid rain has become a major environmental issue on a global scale, posing serious threats to ecosystems, buildings, and human health. The acid rain is primarily formed through reaction of sulfur oxides and nitrogen oxides in the atmosphere with water. These pollutants mainly originate from industrial emissions, vehicle exhaust, and combustion of fossil fuels. A detection of acid rain components is crucial for assessing environmental quality, formulating pollution control strategies, and studying the impacts of acid rain on ecosystems. Accurate detection of acid rain components helps government departments develop effective environmental protection policies, enables researchers to gain deeper insights into the formation mechanisms and environmental effects of the acid rain, and provides a basis for pollution control in industrial enterprises. Therefore, the detection of acid rain components holds significant importance in various fields such as environmental protection, scientific research, and industrial development. Currently, main techniques for detecting acid rain components include ion chromatography, electrical conductivity measurement, and titration. The ion chromatography is the most commonly used method, which determines the acid rain components by separating and quantitatively analyzing various ions present in it. The electrical conductivity measurement indirectly estimates the acidity and ion concentration of acid rain by measuring its electrical conductivity. The titration is mainly used to determine a pondus hydrogenii (pH) value and an acidity of acid rain. The working principles of these methods are based on chemical analysis and physical measurements, and they can provide relatively accurate information about acid rain components. However, these traditional methods have several limitations: First, they typically require specialized laboratory equipment and personnel, making it difficult to achieve rapid on-site detection; second, the processes of sample collection and handling may introduce errors; third, these methods are often time-consuming and cannot meet the demands of large-scale, high-frequency monitoring; finally, the sensitivity and precision of some methods still need improvement, especially for the detection of low-concentration ions.

To address the above issues, researchers have developed some new detection methods, such as spectroscopic analysis, electrochemical sensors, and biosensors. These methods have improved upon certain shortcomings of traditional techniques, such as increasing detection speed or portability. However, these methods still have some drawbacks. First, they can usually only detect a limited range of ions, making it difficult to comprehensively analyze acid rain components. Second, the accuracy and stability of these methods are often significantly affected by environmental factors. Third, they lack adaptive capabilities, making it difficult to cope with complex and variable real-world environments. Finally, these methods usually require frequent calibration and maintenance, increasing the cost and difficulty of use.

Therefore, there is an urgent need for a technical solution that can reduce detection costs, improve detection accuracy, and enhance adaptive capabilities.

### SUMMARY

In order to address the shortcomings of the related art, the disclosure provides an acid rain composition detection chip, which solves the technical problems of high cost, low detection sensitivity and accuracy of acid rain ion concentration detection in the related art.

An acid rain composition detection chip includes one or more processors and one or more data interfaces. The one or more processors through the one or more data interfaces, to read and execute acid rain composition detection instructions stored on a target storage medium, and the acid rain composition detection instructions are configured, when executed by the one or more processors, to: obtain a pH value and an electrical conductivity of a target acid rain sample, and combine with a concentration equilibrium of preset ion species and a thermodynamic model to construct an ion equation system; calculate a residual error by substituting an ion concentration matrix initialized into the ion equation system, and perform one or more times of iterative updating on the ion concentration matrix to obtain an approximate solution of the ion equation system; construct regression models respectively corresponding to ion concentrations, and input data including the pH value, the electrical conductivity and the approximate solution into the regression models to obtain predicted values for the respective ion concentrations; and fuse, based on the pH value and the electrical conductivity, the approximate solution and the predicted values to obtain concentration values of ions in the target acid rain sample.

In an embodiment, the acid rain composition detection instructions are configured, when executed by the one or more processors, to calculate a residual error by substituting an ion concentration matrix initialized into the ion equation system, and perform one or more times of iterative updating on the ion concentration matrix to obtain an approximate solution of the ion equation system, includes to: initialize parameter vectors including initial estimated values of the ion concentrations to obtain the ion concentration matrix initialized; substitute the ion concentration matrix initialized into the ion equation system to calculate the residual error; calculate a Jacobian matrix of the ion equation system, and combine with the residual error to solve an increment equation thereby obtaining an increment as solved; perform cumulative updating on the ion concentration matrix by using the increment; and perform one or more times of iterative updating on the ion concentration matrix, and stop, in response to an absolute value of the residual being less than a first threshold or the increment being less than a second threshold, iterative updating, thereby obtaining an ion concentration matrix as the approximate solution of the ion equation system.

In an embodiment, the first threshold is obtained according to the following expression:

$${τ}_{1} = α \cdot ( 1 - {e}^{- β n} ) \cdot {( \frac{pH}{7} )}^{γ} \cdot {( \frac{σ}{{σ}_{0}} )}^{δ} \cdot {log}_{10} ( 1 + {\sum }_{i} {c}_{i} )$$

where τ₁ represents the first threshold, a represents a scaling factor with a value of 0.03, β represents a parameter controlling a convergence speed and is with a value of 0.27, n represents current iteration number, pH represents the pH value of the target acid rain sample, σ represents the electrical conductivity of the target acid rain sample, σ₀ represents a standard electrical conductivity with a value of 1 micro Siemen per centimeter (μS/cm), γ represents a pH adjustment parameter with a value of 0.5, δ represents an electrical conductivity adjustment parameter with a value of 0.25, and cᵢ represents a concentration value of an i-th ion in the ion concentration matrix.

In an embodiment, the second threshold is obtained according to the following expression:

$${τ}_{2} = ε \cdot 1.31 \cdot {( \frac{σ}{{σ}_{0}} )}^{λ} \cdot ( 1 - {e}^{- θ {\sum }_{i} \vert Δ {c}_{i} \vert / {c}_{0}} ) \cdot {[ {log}_{10} ( 1 + {\sum }_{i} {c}_{i}^{2} ) ]}^{μ}$$

where τ₂ represents the second threshold, ε represents a base threshold with a value of 1e⁻⁶ (i.e., 1×10⁻⁶), σ represents the electrical conductivity of the target acid rain sample, σ₀ represents a standard electrical conductivity with a value of 1 μS/cm, A represents an influence factor of the electrical conductivity and is with a value of 0.53, θ represents an influence factor of concentration change and is with a value of 0.46, Δcᵢ represents a change amount of a concentration of an i-th ion of current iteration, cᵢ represents a concentration value of the i-th ion in the ion concentration matrix, c₀ represents a reference concentration with a value of 1 mole per liter (mol/L), and μ represents an influence factor of a total ion concentration and is with a value of 0.3.

In an embodiment, the acid rain composition detection instructions are further configured, when executed by the one or more processors, before inputting data including the pH value, the electrical conductivity and the approximate solution into the regression models to obtain predicted values for the respective ion concentrations, to: collect multiple acid rain samples, and construct a training dataset using pH values, electrical conductivities and approximate solutions of ion concentrations corresponding to the plurality of acid rain samples as input features and using actual ion concentrations measured by high-precision ion chromatography as labels; and construct a loss function based on a chemical equilibrium equation, and perform integrated training on the regression models.

In an embodiment, the loss function is constructed based on the chemical equilibrium equation as follows:

$$L = MSE + {λ}_{1} {\vert \sum ( {z}_{i} \cdot {C}_{i , predicted} ) - 0 \vert}^{2} + {λ}_{2} \cdot {L}_{reg}$$

where L represents the loss function, MSE represents a mean squared error term, λ₁ represents a first coefficient, zᵢ represents a charge number of an i-th ion, C_{i, predicted} represents a predicted concentration of the i-th ion, λ₂ represents a second coefficient, and L_{reg} represents a regularization term.

In an embodiment, the acid rain composition detection instructions are further configured, when executed by the one or more processors, to: utilize acid rain data from another region or laboratory to improve performance of the regression models in a target region through a transfer learning method; and/or during the integrated training, simultaneously predict ion concentrations and other related parameters to achieve multi-task learning training on the regression models, wherein the other related parameters include acid deposition flux.

In an embodiment, the acid rain composition detection instructions are configured, when executed by the one or more processors, to fuse, based on the pH value and the electrical conductivity, the approximate solution and the predicted values to obtain concentration values of ions in the target acid rain sample, includes to: determine a weighting coefficient based on the pH value and the electrical conductivity, and perform weighted fusion on the approximate solution and the predicted values; wherein the weighting coefficient is expressed as follows:

$$w = \frac{1}{1 + exp ( - a ( pH - {pH}_{0} ) - b ( EC - {EC}_{0} ) )}$$

where w represents the weighting coefficient, a and b represent adjustment parameters, pH represents the pH value of the target acid rain sample, EC represents the electrical conductivity of the target acid rain sample, and pH₀ and EC₀ represent base values; construct an objective optimization problem based on an ion non-negativity constraint, a charge balance constraint, and an electrical conductivity constraint; transform the objective optimization problem into equality constraints, and construct a Lagrangian function; and perform iterative solving on Karush-Kuhn-Tucker (KKT) conditions using Newton's method to obtain the concentration values of the ions in the target acid rain sample.

In the acid rain composition detection chip provided by the disclosure, which can achieve rapid and accurate detection of the main ion components and their concentrations in the acid rain by combining mathematical models and machine learning algorithms. The acid rain composition detection chip of the disclosure has the advantages of fast detection speed, low cost, high accuracy, and wide applicability.

It should be understood that the content described in the disclosure is not intended to limit the key or important features of the embodiments disclosed herein, nor is it intended to limit the scope of the disclosure. The other features disclosed herein will become easily understood through the following description.

### BRIEF DESCRIPTION OF DRAWINGS

The above and other features, advantages, and aspects of the various embodiments disclosed herein will become more apparent with reference to the attached drawings and detailed explanations below. The attached drawings are used for a better understanding of the present solution and do not constitute a limitation of the disclosure. The same or similar reference numerals represent the same or similar elements.

FIG. 1 illustrates a schematic block diagram of an acid rain composition detection chip according to an embodiment of the disclosure.

FIG. 2 illustrates a schematic flowchart of acid rain composition detection instructions when being executed according to an embodiment of the disclosure.

FIG. 3 illustrates a schematic flowchart of acid rain ion concentration approximate calculation instructions when being executed according to an embodiment of the disclosure.

### DETAILED DESCRIPTION OF EMBODIMENTS

In order to clarify the purpose, technical solution, and advantages of the disclosure, a clear and complete description of the technical solution of the disclosure will be provided below in conjunction with the attached drawings. Apparently, the described embodiments are a part of the embodiments, not all embodiments. Based on the described embodiments in the disclosure, all other embodiments obtained by those skilled in the art without creative labor are within the scope of protection of the disclosure.

In addition, the term “and/or” in the disclosure is used solely to describe the relationship between associated objects, indicating that three possible relationships may exist. For example, “A and/or B” may represent: only A, both A and B present simultaneously, or only B. Furthermore, the character “/” in the disclosure generally indicates an “or” relationship between the associated objects.

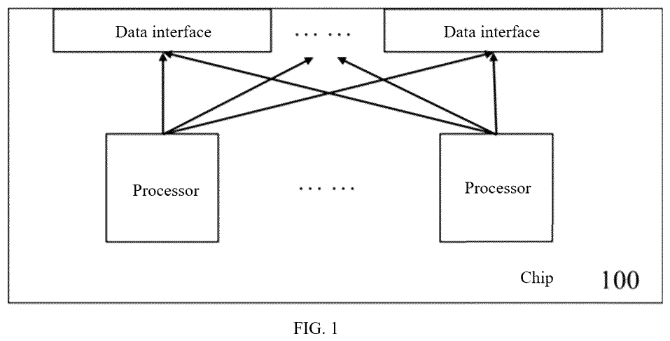

FIG. 1 illustrates a schematic block diagram of an acid rain composition detection chip according to an embodiment of the disclosure. It should be understood that the acid rain composition detection chip shown in the attached drawings is illustrative rather than restrictive. This means that the structure of the acid rain composition detection chip involved is not limited to a specific form or design, but is presented as an example. In other words, the structure shown in the attached drawings can be regarded as a way to clearly describe relevant concepts and relationships, and does not exclude other possible forms of structure. Therefore, when interpreting the structure shown in the attached drawings, it should be understood that the acid rain composition detection chip has flexibility and diversity, and its purpose is to provide an exemplary description rather than a limitation on a specific form.

As shown in FIG. 1, a acid rain composition detection chip 100 includes processors and data interfaces, the processors are configured, through the one or more data interfaces, to read and execute acid rain composition detection instructions stored on a target storage medium.

The acid rain composition detection instructions are configured, when executed by the one or more processors, to: obtain a pH value and an electrical conductivity of a target acid rain sample, and combine with a concentration equilibrium of preset ion species and a thermodynamic model to construct an ion equation system; calculate a residual error by substituting an ion concentration matrix initialized into the ion equation system, and perform one or more times of iterative updating on the ion concentration matrix to obtain an approximate solution of the ion equation system; construct regression models respectively corresponding to ion concentrations, and input data including the pH value, the electrical conductivity and the approximate solution into the regression models to obtain predicted values for the respective ion concentrations; and fuse, based on the pH value and the electrical conductivity, the approximate solution and the predicted values to obtain concentration values of ions in the target acid rain sample.

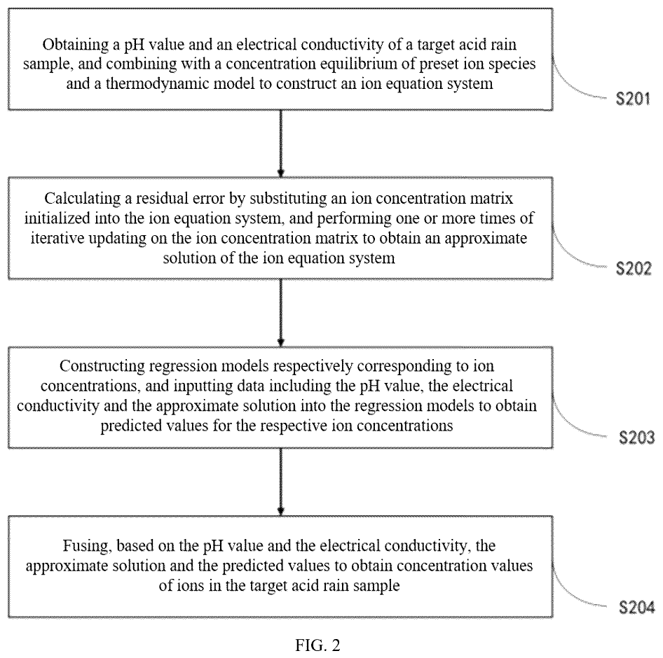

FIG. 2 illustrates a schematic flowchart of acid rain composition detection instructions when being executed according to an embodiment of the disclosure. The disclosure proposes a acid rain composition detection chip for determining the ion compositions and concentration of acid rain based on the pH value and the electrical conductivity. By measuring the pH value and the electrical conductivity of a rainwater sample and integrating mathematical models with machine learning algorithms, the acid rain composition detection chip enables rapid and accurate detection of the main ion components and their concentrations in acid rain. The acid rain composition detection chip offers advantages such as fast detection speed, low cost, high accuracy, and wide applicability, thereby providing an innovative technical solution for acid rain monitoring and research.

Specifically, as shown in FIG. 2, in S201: a pH value and an electrical conductivity of a target acid rain sample are obtained, and combined with a concentration equilibrium of preset ion species and a thermodynamic model to construct an ion equation system.

In an embodiment, for sample collection and pretreatment, clean polyethylene containers can be used to collect a rainwater sample (i.e., the target acid rain sample) to avoid contamination. The sample volume V (in liters) should be measured accurately to 0.1 milliliters (mL). The rainwater sample is filtered using a polytetrafluoroethylene (PTFE) membrane with a pore size of 0.45 micrometers (μm) to remove suspended solids. The filtered sample is then transferred into a clean polyethylene bottle and sealed for storage. The temperature during sample storage and measurement is controlled at 25±1° C. to ensure the accuracy of subsequent measurements.

The pH value and the electrical conductivity are measured. On the one hand, for pH measurement: a pH meter calibrated at three points (pH 4.01, 7.00, and 10.01) is used to measure the pH value of the rainwater sample. The measurement accuracy should reach ±0.01 pH units. A triple parallel determination method is adopted, with each measurement spaced 1 minute apart, and an average value is taken as a final result. On the other hand, for conductivity measurement: a conductivity meter calibrated with a standard potassium chloride (KCl) solution (0.01 mol/L) is used to measure the electrical conductivity K micro-Siemen per centimeter (μS/cm) of the rainwater sample. The measurement accuracy should reach ±0.5%. A triple parallel determination method is also adopted, with each measurement spaced 1 minute apart, and an average value is taken as a final result.

Through the above operations, the pH value and the electrical conductivity of the target acid rain sample can be obtained and stored in the corresponding target storage medium, so that the acid rain composition detection chip can read them via the data interfaces.

The ion equation system is constructed based on the concentration equilibrium of preset ion species and a thermodynamic model. It should be noted that, according to the principle of electrical neutrality, an equilibrium equation is established between the total equilibrium concentrations of cations and anions: Σ[Cation⁺]=Σ[Anion⁻]. The main ions considered in the acid rain include: H⁺, NH₄⁺, Ca²⁺, Mg²⁺, Na⁺, K⁺, OH⁻, F⁻, SO₄²⁻, NO₃⁻, Cl⁻, HCO₃⁻, and C₂O₄²⁻. For each ion i, its equilibrium concentration [i]_{eq} can be expressed as: [i]_{eq} =cᵢ×|zᵢ|, where cᵢ represents a molar concentration of the ion (mole per liter abbreviated as mol/L), and zᵢ represents a valence of the ion. The specific equilibrium equation can be expressed as:

$$[ {H}^{+} ] + [ {NH}_{4}^{+} ] + 2 [ {Ca}^{2 +} ] + 2 [ {Mg}^{2 +} ] + [ {Na}^{+} ] + [ {K}^{+} ] = [ {F}^{-} ] + [ {OH}^{-} ] + 2 [ {SO}_{4}^{2 -} ] + [ {NO}_{3}^{-} ] + [ {Cl}^{-} ] + [ {HCO}_{3}^{-} ] + 2 [ {C}_{2} {O}_{4}^{2 -} ] .$$

A thermodynamic model is established. To accurately describe the behavior of ions in solution (i.e., the rainwater sample), an extended Debye-Hckel equation can be used to calculate the activity coefficient γᵢ of each ion:

$$log {γ}_{i} = - {Az}_{i}^{2} \frac{\sqrt{I}}{1 + {\mathring{a}}_{i} B \sqrt{I}} + bI$$

where A and B represent temperature-dependent constants, at 25° C., A=0.5085 and B=0.3281; zᵢ represents a valence of an i-th ion;

$${\mathring{a}}_{i}$$

represents an ion size parameter (in nm) of the i-th ion; b represents an empirical coefficient (taken as 0.1); I represents an ionic strength, calculated as:

$$I = 0.5 \sum ( {c}_{i} {z}_{i}^{2} ) .$$

For the main ions, the values of

$${\mathring{a}}_{i} ( in nm )$$

can be assigned as follows: H⁺: 0.9; NH4⁺: 0.25; Ca²⁺: 0.6; Mg²⁺: 0.8; Na⁺: 0.45; K⁺: 0.3; OH⁻: 0.35; F⁻: 0.35; SO₄²⁻: 0.4; NO³⁻: 0.3; Cl⁻: 0.3; HCO³⁻: 0.45; C₂O₄²⁻: 0.5.

Therefore, based on the pH value, the electrical conductivity, the ion balance, and the thermodynamic model, a nonlinear ion equation system can be constructed as follows:

$$1. pH = - log [ {H}^{+} ] ;$$

$$2. κ = {Λ}^{0} ( {H}^{+} ) [ {H}^{+} ] + {Λ}^{0} ( {NH}_{4}^{+} ) [ {NH}_{4}^{+} ] + {Λ}^{0} ( {Ca}^{2 +} {2 +}^{} ) [ {Ca}^{2 +} ] + {Λ}^{0} ( {Mg}^{2 +} ) [ {Mg}^{2 +} ] + {Λ}^{0} ( {Na}^{+} ) [ {Na}^{+} ] + {Λ}^{0} ( {K}^{+} ) [ {K}^{+} ] + {Λ}^{0} ( {SO}_{4}^{2 -} ) [ {SO}_{4}^{2 -} ] + {Λ}^{0} ( {NO}_{3}^{-} ) [ {NO}_{3}^{-} ] + {Λ}^{0} ( {Cl}^{-} ) [ {Cl}^{-} ] + {Λ}^{0} ( {HCO}_{3}^{-} ) [ {HCO}_{3}^{-} ] ,$$

where Λ⁰ represents a limiting molar conductivity of the ion, with values as follows:

$${Λ}^{0} ( {H}^{+} ) = 349.8 ; {Λ}^{0} ( {NH}_{4}^{+} ) = 735 ; {Λ}^{0} ( {Ca}^{2 +} ) = 119. ; {Λ}^{0} ( {Mg}^{2 +} ) = 106.0 ; {Λ}^{0} ( {Na}^{+} ) = 50.1 ; {Λ}^{0} ( {K}^{+} ) = 735 ; {Λ}^{0} ( {SO}_{4}^{2 -} ) = 160 \text{.0} ; {Λ}^{0} ( {NO}_{3}^{-} ) = 714 ; {Λ}^{0} ( {Cl}^{-} ) = 76.3 ; {Λ}^{0} ( {HCO}_{3}^{-} ) = 44.5 ;$$

$$3. [ {H}^{+} ] + [ {NH}_{4}^{+} ] + 2 [ {Ca}^{2 +} ] + 2 [ {Mg}^{2 +} ] + [ {Na}^{+} ] + [ {K}^{+} ] = [ {F}^{-} ] + [ {OH}^{-} ] + 2 [ {SO}_{4}^{2 -} ] + [ {NO}_{3}^{-} ] + [ {Cl}^{-} ] + [ {HCO}_{3}^{-} ] + 2 [ {C}_{2} {O}_{4}^{2 -} ] ;$$

$$4. {K}_{W} = [ {H}^{+} ] [ {OH}^{-} ] ,$$

where K_{W} represents an ion product constant of water, which is

$$1. \times {10}^{- 14} at 25 ° C . ;$$

$$5. {K}_{{HCO}_{3}} = \frac{[ {H}^{+} ] [ {CO}_{3}^{2 -} ]}{[ {HCO}_{3}^{-} ]} , where {K}_{{HCO}_{3}}$$

represents an ionization constant of bicarbonate ions, which is 5.6×10⁻¹¹ at 25° C.;

$$6. {K}_{{H}_{2} {CO}_{3}} = \frac{[ {H}^{+} ] [ {HCO}_{3}^{-} ]}{[ {H}_{2} {CO}_{3} ]} , where {K}_{{H}_{2} {CO}_{3}}$$

represents a first ionization constant of carbonic acid, which is 4.3×10⁻⁷ at 25° C.;

$$7. {γ}_{i} = {10}^{( - {Az}_{i}^{2} \sqrt{I} / ( 1 + {\mathring{a}}_{i} B \sqrt{I} ) + bI )} ,$$

for each ion specie i, activity coefficient γᵢ of each ion specie is calculated.

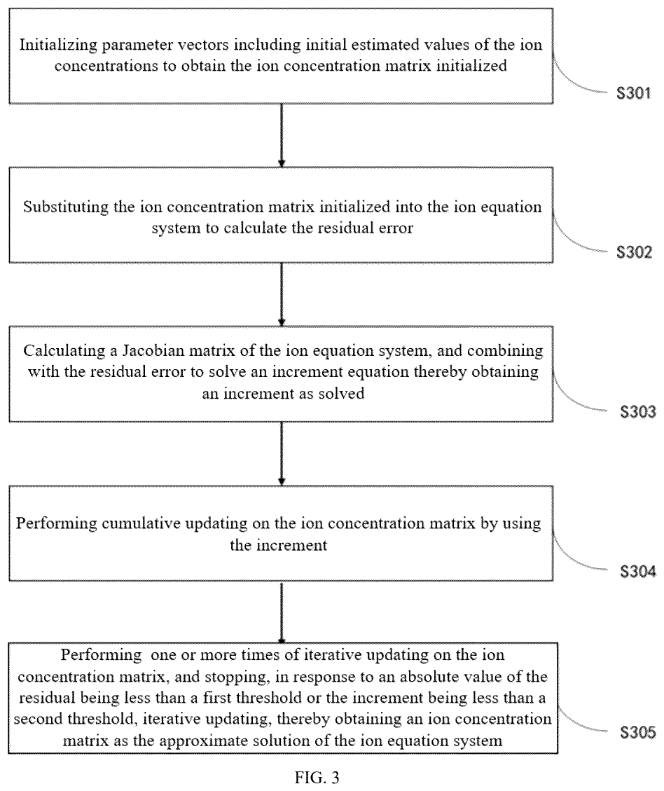

In S202, a residual error is calculated by substituting an ion concentration matrix initialized into the ion equation system, and one or more times of iterative updating are perform ed on the ion concentration matrix to obtain an approximate solution of the ion equation system. In an embodiment (as shown in FIG. 3, specific instruction steps will be explained in FIG. 3), parameter vectors including initial estimated values of the ion concentrations are initialized to obtain the ion concentration matrix initialized. The ion concentration matrix initialized is substituted into the ion equation system to calculate the residual error. A Jacobian matrix of the ion equation system is calculated and is combine with the residual error to solve an increment equation thereby obtaining an increment as solved. Cumulative updating is perform ed on the ion concentration matrix by using the increment. one or more times of iterative updating are performed on the ion concentration matrix, and iterative updating is stopped, in response to an absolute value of the residual being less than a first threshold or the increment being less than a second threshold, thereby obtaining an ion concentration matrix as the approximate solution of the ion equation system.

In S203, regression models respectively corresponding to ion concentrations are constructed, and data including the pH value, the electrical conductivity and the approximate solution is input into the regression models to obtain predicted values for the respective ion concentrations.

It should be noted that, in an embodiment, before inputting data including the pH value, the electrical conductivity and the approximate solution into the regression models to obtain predicted values for the respective ion concentrations, the S203 further includes that: multiple acid rain samples are collected, and a training dataset is constructed using pH values, electrical conductivities and approximate solutions of ion concentrations corresponding to the multiple acid rain samples as input features and actual ion concentrations measured by high-precision ion chromatography are used as labels. a loss function is constructed based on a chemical equilibrium equation, and integrated training is performed on the regression models. The loss function is constructed based on the chemical equilibrium equation as follows:

$$L = MSE + {λ}_{1} \cdot {\vert \sum ( {z}_{i} \cdot {C}_{i , predicted} ) - 0 \vert}^{2} + {λ}_{2} \cdot {L}_{reg}$$

where L represents the loss function, MSE represents a mean squared error term, λ₁ represents a first coefficient, zᵢ represents a charge number of an i-th ion, C_{i, predicted} represents a predicted concentration of the i-th ion, λ₂ represents a second coefficient, and L_{reg} represents a regularization term.

Specifically, the regression models can use a Random Forest model with the following parameter settings: number of decision trees: 100, maximum tree depth: 10, minimum number of samples per leaf node: 5, and the feature selection criterion can be based on the loss function constructed from the chemical equilibrium equation. The model training process employs k-fold cross-validation (k=5) to evaluate performance and prevent overfitting. For each ion (each ion specie) i, a separate regression model fᵢ is established:

$${c}_{i\_optimized} = {f}_{i} ( pH , κ , {c}_{1} , {c}_{2} , … , {c}_{n} )$$

where c_{i_optimized} represents an optimized predicted concentration of the i-th ion.

Specific steps are as follows: First, data preparation: a large number of acid rain samples (n>1000) are collected, the pH value and the electrical conductivity of the acid rain samples are simultaneously measured, and the actual concentrations of each ion are determined using ion chromatography. The method described in the above embodiment is used to calculate the initial ion concentrations. The dataset is randomly split into a training set (80%) and a test set (20%). Second, feature engineering: The input features X are defined as [pH, κ, c₁, c₂, . . . , cₙ], and the target variable y is an actual ion concentration. Next, model training: For each ion i, a separate random forest regression model fᵢ is trained. Hyperparameters can be optimized using Grid Search with 5-fold cross-validation. Finally, model performance on the test set is assessed by calculating the loss function constructed based on the chemical equilibrium equation.

In an embodiment, the detection instructions further includes that: acid rain data from another region or laboratory is utilized to improve performance of the regression models in a target region through a transfer learning method; and/or during the integrated training on the regression models, ion concentrations and other related parameters are simultaneously predicted to achieve multi-task learning training on the regression models, and the other related parameters include acid deposition flux.

In S204, the approximate solution and the predicted values are fused to obtain concentration values of ions in the target acid rain sample based on the pH value and the electrical conductivity.

In an embodiment, a weighting coefficient are determined based on the pH value and the electrical conductivity to perform weighted fusion on the approximate solution and the predicted values. The weighting coefficient is expressed as follows:

$$w = \frac{1}{1 + exp ( - a ( pH - {pH}_{0} ) - b ( EC - {EC}_{0} ) )} ,$$

where w represents the weighting coefficient, a and b represent adjustment parameters, pH represents the pH value of the target acid rain sample, EC represents the electrical conductivity of the target acid rain sample, and pH₀ and EC₀ represent base values. An objective optimization problem is constructed based on an ion non-negativity constraint, a charge balance constraint, and an electrical conductivity constraint. The objective optimization problem is transformed into equality constraints and a Lagrangian function is constructed. Iterative solving is performed on Karush-Kuhn-Tucker (KKT) conditions using Newton's method to obtain the concentration values of the ions in the target acid rain sample.

This step aims to comprehensively utilize the approximate solution of the ion equation system and the predicted values from the regression models to obtain a more accurate estimation of ion concentrations through data fusion techniques. Specifically, for each ion i, there are two concentration estimates: the approximate solution from the ion equation system, denoted as

$${c}_{i}^{*} ,$$

and the predicted value from the regression model, denoted as

$${c}_{i}^{′} .$$

Weights needed to be assigned to these two estimates based on the reliability of the pH value and the electrical conductivity.

The weighting function w(pH, EC) is defined, which determines the weights based on the measurement accuracy of the pH value and the electrical conductivity. Then, for each ion i, the weighted average value is calculated:

$${c}_{i\_final} = w \cdot {c}_{i}^{*} + ( 1 - w ) \cdot {c}_{i}^{′} .$$

To ensure the physical plausibility of ion concentrations, some constraints need to be applied. For example:
non-negativity constraint: All ion concentrations must be greater than or equal to zero;
charge balance constraint: The total charge of cations should equal the total charge of anions;
electrical conductivity constraint: According to Kohlrausch's law, ion concentrations should satisfy a certain relationship with electrical conductivity;
these constraints can be implemented through an optimization problem:

$$minimize \sum {( {c}_{i\_final} - {c}_{i} )}^{2}$$

$$\text{subject to:}$$

$${c}_{i} \geq 0 for all i$$

$$\sum ( {z}_{i} \cdot {c}_{i} ) = 0$$

$$\vert EC - \sum ( {λ}_{i} \cdot {c}_{i} ) \vert \leq δ$$

where λᵢ represents a molar conductivity of ion i, and δ represents an allowable error range.

This optimization problem can be solved using Quadratic Programming methods. For example, the inequality constraint can first be converted into an equality constraint:

$$\begin{matrix}{c}_{i} - {s}_{i} & = 0 \\ {s}_{i} & \geq 0\end{matrix} ,$$

then the Lagrangian function is constructed:

$$L ( c , s , λ , μ ) = f ( c ) - {λ}^{T} ( g ( c ) + s ) - {μ}^{T} s 3 ) ,$$

next, the Karush-Kuhn-Tucker (KKT) conditions are solved:

$$\begin{matrix}∇ L & = 0 \\ g ( c ) + s & = 0 \\ {μ}_{i} {s}_{i} & = 0 \\ s & \geq 0 \\ μ & \geq 0\end{matrix} ,$$

Afterwards, the Newtons's method can be applied to iteratively solve the KKT conditions. Finally, the cᵢ values representing the final concentration of each ion in the target acid rain sample are obtained.

This fusion method fully leverages the theoretical foundation of the ion equation system and the data-driven characteristics of the regression models, while also considering measurement errors and physical constraints, resulting in more reliable ion concentration estimates. In practical applications, the weighting function and constraint conditions can be adjusted according to specific situations to adapt to different types of acid rain samples and measurement environments.

Furthermore, to further improve detection accuracy, other relevant parameters such as temperature and atmospheric pressure can be introduced, and more complex machine learning models such as deep neural networks or ensemble learning methods can be employed. At the same time, by establishing a large-scale acid rain sample database, the regression models can be continuously optimized and updated, enhancing the applicability and accuracy of the acid rain composition detection chip.

The acid rain composition detection chip provided by the disclosure achieves high-precision detection of ion concentrations in acid rain samples by combining ion balance modeling, machine learning regression, and data fusion techniques. Compared with traditional ion chromatography methods, the detection chip offers advantages such as lower cost and faster speed, making it suitable for large-scale acid rain monitoring. In practical applications, the parameters of each instruction step can be optimized and adjusted according to specific requirements to achieve optimal detection performance.

FIG. 3 illustrates a schematic flowchart of acid rain ion concentration approximate calculation instructions when being executed according to an embodiment of the disclosure. In S301, parameter vectors including initial estimated values of the ion concentrations are initialized to obtain the ion concentration matrix initialized. That is, the parameter vectors β is initialized as β₀, which contains the initial estimated values of the ion concentrations.

In S302, the ion concentration matrix initialized is substituted into the ion equation system to calculate the residual error, and a residual vector is r=y−f(β).

In S303, a Jacobian matrix of the ion equation system is calculated and is combine with the residual error to solve an increment equation thereby obtaining an increment as solved. The Jacobian matrix is

$$J = \frac{\partial f}{\partial β} ,$$

and the increment equation can be expressed as (J^{T}J+λdiag(J^{T}J))δ=J^{T}r.

S304, cumulative updating is performed on the ion concentration matrix by using the increment. A parameter update is given by β=β+δ.

S305, the one or more times of iterative updating is performed the ion concentration matrix, iterative updating is stopped, in response to an absolute value of the residual being less than a first threshold or the increment being less than a second threshold, the one or more iterative updates are stopped, thereby obtaining an iterated ion concentration matrix as the approximate solution of the ion equation system. Specifically, the above mentioned steps are repeated until convergence, with the convergence criteria being ∥δ∥<τ₁ or ∥r∥<τ₂, where τ₁ and τ₂ are predefined thresholds.

In an embodiment, the first threshold is obtained according to the following expression:

$${τ}_{1} = α \cdot ( 1 - {e}^{- β n} ) \cdot {( \frac{pH}{7} )}^{γ} \cdot {( \frac{σ}{{σ}_{0}} )}^{δ} \cdot {log}_{10} ( 1 + {\sum }_{i} {c}_{i} )$$

where τ₁ represents the first threshold, a represents a scaling factor with a value of 0.03, β represents a parameter controlling a convergence speed and is with a value of 0.27, n represents current iteration number, pH represents the pH value of the target acid rain sample, o represents the electrical conductivity of the target acid rain sample, σ₀ represents a standard electrical conductivity with a value of 1 μS/cm, γ represents a pH adjustment parameter with a value of 0.5, δ represents an electrical conductivity adjustment parameter with a value of 0.25, and cᵢ represents a concentration value of the i-th ion in the ion concentration matrix.

In an embodiment, the second threshold is obtained according to the following expression:

$${τ}_{2} = ε \cdot 1.31 \cdot {( \frac{σ}{{σ}_{0}} )}^{λ} \cdot ( 1 - {e}^{- θ {\sum }_{i} \vert Δ {c}_{i} \vert / {c}_{0}} ) \cdot {[ {log}_{10} ( 1 + {\sum }_{i} {c}_{i}^{2} ) ]}^{μ}$$

where τ₂ represents the second threshold, ε represents a base threshold with a value of 1e⁻⁶, σ represents the electrical conductivity of the target acid rain sample, σ₀ represents a standard electrical conductivity with a value of 1 μS/cm, λ represents an influence factor of the electrical conductivity and is with a value of 0.53, θ represents an influence factor of concentration change and is with a value of 0.46, Δcᵢ represents a change amount of a concentration of an i-th ion of current iteration, cᵢ represents a concentration value of the i-th ion in the ion concentration matrix, c₀ represents a reference concentration with a value of 1 mole per liter (mol/L), and μ represents an influence factor of a total ion concentration and is with a value of 0.3.

In addition, it should be understood that the acid rain composition detection chip of the disclosure has been trained and tested on real-world datasets. By integrating mechanisms based on ion balance modeling, machine learning regression, and data fusion techniques, the acid rain composition detection chip has achieved improved detection performance. Table 1 below presents a practical application case, illustrating the detection process and results of the acid rain composition detection chip. A rainwater sample collected from a certain region is measured to have a pH value of 4.32 and an electrical conductivity of 35.6 μS/cm. The acid rain composition detection chip is used to analyze the ion compositions and concentration, and the following results are obtained.

TABLE 1
Comparison results of real dataset detection

| | | Relative | | Method |
|---|---|---|---|---|
| | | standard | | detection |
| | | deviation | Rate of | limit |
| Ion | Concentration | (RSD) | recovery | (MDL) |
| species | (μmol/L) | (%) | (%) | (μmol/L) |
| H⁺ | 47.9 | 2.1 | 98.5 | 0.5 |
| NH⁴⁺ | 15.3 | 3.4 | 97.2 | 0.8 |
| Ca²⁺ | 22.7 | 2.8 | 101.3 | 1.2 |
| Mg²⁺ | 8.6 | 3.7 | 99.1 | 0.6 |
| Na⁺ | 19.4 | 2.5 | 102.4 | 0.9 |
| K⁺ | 3.2 | 4.2 | 96.8 | 0.3 |
| SO₄²⁻ | 41.5 | 2.3 | 98.9 | 1.5 |
| NO³⁻ | 28.9 | 2.9 | 100.7 | 1.1 |
| Cl⁻ | 17.8 | 3.1 | 99.5 | 0.7 |
| HCO³⁻ | 5.6 | 4.5 | 95.6 | 0.4 |

From the table 1, it can be seen that the cation-anion balance error E=2.3%, which is within the acceptable range (±5%). When compared with the results from ion chromatography (IC), the average relative error is 6.8%, the correlation coefficient R is 0.994, and the root mean square error (RMSE) is 2.7 micromoles per liter (μmol/L). Regarding a linear range, for the major ions

$$( {SO}_{4}^{2 -} , {NO}_{3}^{-} , {NH}_{4}^{+} ) ,$$

the linear range is 1-1000 μmol/L with R2>0.999; for the minor ions (Ca²⁺, Mg²⁺, Na⁺, K⁺, Cl⁻), the linear range is 0.5-500 μmol/L with R2>0.998.

In addition, in inter-laboratory comparisons, cross-validation is conducted with three laboratories, and all Z-scores fall within the range of ±2, indicating reliable results. Standard Reference Material (SRM) testing is also performed using NIST SRM 2694a (Simulated Rainwater), with relative errors (RE) for all ions being less than ±8%. The results demonstrate that the acid rain composition detection chip offers high accuracy, precision, and reliability, and is capable of meeting the requirements for acid rain monitoring.

In summary, the disclosure provides the acid rain composition detection chip for detecting the acid rain ion composition and ion concentration based on the pH value and the electrical conductivity, which achieves rapid, accurate, and low-cost detection of acid rain compositions by combining mathematical models and machine learning techniques. The acid rain composition detection chip offers the following advantages:
fast detection speed: only pH value and electrical conductivity need to be measured to obtain complete ion component information, reducing detection time to one-tenth of traditional methods.
low cost: the need for expensive equipment such as ion chromatographs is eliminated, reducing detection costs by more than 80%.
high accuracy: through nonlinear optimization and machine learning models, the detection accuracy for major ions can reach within ±10%.
wide applicability: suitable for rapid on-site detection and large-scale monitoring, and applicable to various types of precipitation samples.

From the description of the above embodiments, those skilled in the art can clearly understand that all or part of the steps in the method of the embodiments may be implemented by software in conjunction with a general-purpose hardware platform. Based on this understanding, the technical solutions of the disclosure may essentially, or the part contributing to the related art, be embodied in the form of a software product. This computer software product may be stored in a storage medium, such as read only memory or random-access memory (ROM/RAM), magnetic disk, optical disk, etc., and includes several instructions for enabling a computer device (which may be a personal computer, a server, or a network communication device such as a media gateway, etc.) to execute the methods described in the embodiments or parts thereof.

It should be understood that the various forms of the flow shown above may be used to reorder, add, or delete steps. For example, the steps described in the disclosure may be executed in parallel, sequentially, or in a different order, as long as the desired results of the technical solutions in the disclosure can be achieved, which is not limited herein.

The above specific embodiments do not constitute a limitation on the scope of protection of the disclosure. Those skilled in the art should understand that various modifications, combinations, sub-combinations, and substitutions may be made according to design requirements and other factors. Any modifications, equivalent substitutions, and improvements made within the spirit and principles of the disclosure shall be included within the scope of protection of the disclosure.

What is claimed is:

1. An acid rain composition detection chip, comprising: one or more processors, and one or more data interfaces; wherein the one or more processors are configured, through the one or more data interfaces, to read and execute acid rain composition detection instructions stored on a target storage medium, the acid rain composition detection instructions are configured, when executed by the one or more processors, to:
obtain a pH value and an electrical conductivity of a target acid rain sample, and combine with a concentration equilibrium of preset ion species and a thermodynamic model to construct an ion equation system;
calculate a residual error by substituting an ion concentration matrix initialized into the ion equation system, and perform one or more times of iterative updating on the ion concentration matrix to obtain an approximate solution of the ion equation system;
construct regression models respectively corresponding to ion concentrations, and input data including the pH value, the electrical conductivity and the approximate solution into the regression models to obtain predicted values for the respective ion concentrations; and
fuse, based on the pH value and the electrical conductivity, the approximate solution and the predicted values to obtain concentration values of ions in the target acid rain sample.

2. The acid rain composition detection chip as claimed in claim 1, wherein the acid rain composition detection instructions are configured, when executed by the one or more processors, to calculate a residual error by substituting an ion concentration matrix initialized into the ion equation system, and perform one or more times of iterative updating on the ion concentration matrix to obtain an approximate solution of the ion equation system, comprises to:
initialize parameter vectors including initial estimated values of the ion concentrations to obtain the ion concentration matrix initialized;
substitute the ion concentration matrix initialized into the ion equation system to calculate the residual error;
calculate a Jacobian matrix of the ion equation system, and combine with the residual error to solve an increment equation thereby obtaining an increment as solved;
perform cumulative updating on the ion concentration matrix by using the increment; and
perform one or more times of iterative updating on the ion concentration matrix, and stop, in response to an absolute value of the residual being less than a first threshold or the increment being less than a second threshold, iterative updating, thereby obtaining an ion concentration matrix as the approximate solution of the ion equation system.

3. The acid rain composition detection chip as claimed in claim 2, wherein the first threshold is obtained according to the following expression:
$${τ}_{1} = α \cdot ( 1 - {e}^{- β n} ) \cdot {( \frac{pH}{7} )}^{γ} \cdot {( \frac{σ}{{σ}_{0}} )}^{δ} \cdot {log}_{10} ( 1 + {\sum }_{i} {c}_{i} )$$
where τ₁ represents the first threshold, a represents a scaling factor with a value of 0.03, β represents a parameter controlling a convergence speed and is with a value of 0.27, n represents current iteration number, pH represents the pH value of the target acid rain sample, σ represents the electrical conductivity of the target acid rain sample, τ₀ represents a standard electrical conductivity with a value of 1 micro Siemen per centimeter (μS/cm), γ represents a pH adjustment parameter with a value of 0.5, δ represents an electrical conductivity adjustment parameter with a value of 0.25, and cᵢ represents a concentration value of an i-th ion in the ion concentration matrix.

4. The acid rain composition detection chip as claimed in claim 2, wherein the second threshold is obtained according to the following expression:
$${τ}_{2} = ε \cdot 1.31 \cdot {( \frac{σ}{{σ}_{0}} )}^{λ} \cdot ( 1 - {e}^{- θ {\sum }_{i} \vert {Δc}_{i} \vert / {c}_{0}} ) \cdot {[ {log}_{10} ( 1 + {\sum }_{i} {c}_{i}^{2} ) ]}^{μ}$$
where τ₂ represents the second threshold, ε represents a base threshold with a value of 1e⁻⁶, 94 represents the electrical conductivity of the target acid rain sample, σ₀ represents a standard electrical conductivity with a value of 1 μS/cm, A represents an influence factor of the electrical conductivity and is with a value of 0.53, θ represents an influence factor of concentration change and is with a value of 0.46, Δcᵢ represents a change amount of a concentration of an i-th ion of current iteration, cᵢ represents a concentration value of the i-th ion in the ion concentration matrix, c₀ represents a reference concentration with a value of 1 mole per liter (mol/L), and μ represents an influence factor of a total ion concentration and is with a value of 0.3.

5. The acid rain composition detection chip as claimed in claim 1, wherein the acid rain composition detection instructions are further configured, when executed by the one or more processors, before inputting data including the pH value, the electrical conductivity and the approximate solution into the regression models to obtain predicted values for the respective ion concentrations, to:
collect a plurality of acid rain samples, and construct a training dataset using pH values, electrical conductivities and approximate solutions of ion concentrations corresponding to the plurality of acid rain samples as input features and using actual ion concentrations measured by high-precision ion chromatography as labels; and
construct a loss function based on a chemical equilibrium equation, and perform integrated training on the regression models.

6. The acid rain composition detection chip as claimed in claim 5, wherein the loss function is constructed based on the chemical equilibrium equation as follows:
$$L = MSE + {λ}_{1} {\vert \sum ( {z}_{i} \cdot {C}_{i , predicted} ) - 0 \vert}^{2} + {λ}_{2} \cdot {L}_{reg}$$
where L represents the loss function, MSE represents a mean squared error term, λ₁ represents a first coefficient, zᵢ represents a charge number of an i-th ion, C_{i, predicted} represents a predicted concentration of the i-th ion, λ₂ represents a second coefficient, and L_{reg} represents a regularization term.

7. The acid rain composition detection chip as claimed in claim 5, wherein the acid rain composition detection instructions are further configured, when executed by the one or more processors, to:
utilize acid rain data from another region or laboratory to improve performance of the regression models in a target region through a transfer learning method; and/or during the integrated training, simultaneously predict ion concentrations and other related parameters to achieve multi-task learning training on the regression models, wherein the other related parameters comprise acid deposition flux.

8. The acid rain composition detection chip as claimed in claim 1, wherein the acid rain composition detection instructions are configured, when executed by the one or more processors, to fuse, based on the pH value and the electrical conductivity, the approximate solution and the predicted values to obtain concentration values of ions in the target acid rain sample, comprises to:
determine a weighting coefficient based on the pH value and the electrical conductivity, and perform weighted fusion on the approximate solution and the predicted values; wherein the weighting coefficient is expressed as follows:
$$w = \frac{1}{1 + exp ( - a ( pH - {pH}_{0} ) - b ( EC - {EC}_{0} ) )}$$
where w represents the weighting coefficient, a and b represent adjustment parameters, pH represents the pH value of the target acid rain sample, EC represents the electrical conductivity of the target acid rain sample, and pH₀ and EC₀ represent base values;
construct an objective optimization problem based on an ion non-negativity constraint, a charge balance constraint, and an electrical conductivity constraint;
transform the objective optimization problem into equality constraints, and construct a Lagrangian function; and
perform iterative solving on Karush-Kuhn-Tucker (KKT) conditions using Newton's method to obtain the concentration values of the ions in the target acid rain sample.
